(19) United States
(12) Patent Application Publication
(10) Pub. No.: US 2003/0193481 A1
(43) Pub. Date: Oct. 16, 2003

(54) Touch-sensitive input overlay for graphical user interface

(76) Inventor: Alexander Sokolsky, San Jose, CA (US)

Correspondence Address: APPLIED MATERIALS, INC., 2881 SCOTT BLVD. M/S 2061, SANTA CLARA, CA, 95050, US

(21) Appl. No.: 10/121,203

(22) Filed: Apr. 12, 2002

(51) Int. Cl. G09G 5/00

(52) U.S. Cl. 345/173; 345/764

(57) ABSTRACT

An improved graphical user interfaces system is disclosed that includes a touch-sensitive input overlay. The touch-sensitive input overlay is configured to enable a flexible complementary or replacement input mode for entering and navigating text and information on a traditional graphical user interface, without the aid of a mouse or keyboard. The improved graphical interface system can be embodied in a specially programmed computer system, a computer implemented method, or a computer readable medium configured to cause a computer to perform the underlying method.

### BACKGROUND

1. Field of the Invention

The invention relates to graphical user interfaces, and more particularly to touch-screen graphical user interfaces for computer systems.

2. Background Information

As computers are deployed in an increasing number of environments and for an increasing number of applications, it is becoming more and more common that users expect a graphical user interface (“GUI”) that simplifies the interaction between the user and a program executing on the computer (or over a network on a remote computer).

Since the GUI's infamous conception at Xerox PARC labs in the 1980s, and subsequent commercialization by Apple Computer shortly thereafter, the GUI has become the interface of choice of nearly every operating system to date. Linux (TM), Solaris (TM), and Microsoft Windows (TM) all have GUIs to promote ease of use between users and application programs running over these operating systems.

While the underlying concept of a GUI is consistent between implementations, GUIs do exhibit certain characteristics, which are note here.

The standard and most ubiquitous GUI is the icon-based interface, in which a pointing device, such a mouse or a capacitive pointer is used to identify and select the icon and execute a program on the computer system. Such systems are evidenced by commercially available operating systems like those available from Apple Computer, and Microsoft Corporation, which typically have a full-screen display. However, the capacitive pointer is more frequently found in systems with a small-screen display, or in systems where display real estate is severely limited, such as in a personal digital assistant.

Occasionally, touch-screen implementations of the GUI are employed. Again, these are found mostly in systems where display real estate is limited, but also in systems where the GUI is relatively simple. For instance, most commercial department stores have networked bridal registries that have a full-screen display but no keyboard or mouse. Instead, the GUI is a set of push buttons and a keyboard that appear on the display in fixed locations and that are responsive to touch. In a normal operation, a user navigates through a series of screens with limited options and must select from a sequentially pre-ordained input with an appropriate touch response (either a push button or a keyboard entry) in the fixed location.

Besides commercial implementations described above, certain patent documents disclose elements of some touch-screen GUI systems.

For instance, U.S. Pat. No. 6,335,725, by Koh et al. (the '725 patent), discloses a method for partitioning a touch-screen for data input. The '725 patent partitions a screen into two fixed portions and uses a touch-input in the first portion to navigate with scroll buttons in the second portion. U.S. Pat. No. 6,310,634, by Bodnar et al. is similar. Also similar is U.S. Pat. No. 6,346,955, by Moon et al., but rather than using scroll bars or scroll buttons, a tab and button system is disclosed. Slightly different is U.S. Pat. No. 6,037,937, by Beaton et al., which provides a more flexible GUI tool, here a transparent navigation tool that does not obstruct the view of data on a small screen.

In each of the above examples, two issues appear to motivate the use of a touch-screen GUI: a relatively small amount of display real estate, and the implementation of the GUI for a portable computing device where a mouse or other peripheral navigation device is not practical.

Another type of system where a touch-screen GUI is employed is in industrial control systems, which either operate physical plants (e.g. a factory, an HVAC system, etc.) or medical equipment. In these systems, the environmental conditions may drive the choice of a touch-screen GUI. U.S. Pat. No. 6,063,030, by Vara et al. (the '030 patent), discloses such a system.

Similar to the '030 patent is U.S. Pat. No. 5,559,301, by Bryan et al. (the '301 patent). The '301 patent discloses a system where a computer emulates an analog interface in the real-world. Here, buttons and sliders are employed on a GUI to tune or balance a sound processing system, just like the buttons and sliders are used on a traditional equalizer. In each of two above patents, the presentation and manipulation of the touch-inputs for data entry is very rigid, much like the bridal registry systems mentioned above. In these systems, the input is simple, predictable, and consistent.

### SUMMARY OF THE INVENTION

A computer implemented apparatus and method for an improved graphical user interface with a touch-sensitive input overlay is described. According to an embodiment, the computer includes program modules (software) configured to cause one or more microprocessors to: determine a location of a first touch input received on the display; correlate the first touch input to a control on the graphical user interface; determine a location to present a touch-sensitive input overlay relative to the control; place the touch-sensitive input overlay at the location; and receive a second touch input in the area defined by the touch-sensitive input overlay, the second touch input aiding entry of a parameter into the control. Corresponding computer implemented methods and data structures are also described. These and other embodiments are presented in the detailed description, figures and claims that follow.

### BRIEF DESCRIPTION OF THE DRAWINGS

FIG. 1 is a diagram of a touch-sensitive input overlay for a graphical user interface.

FIG. 2 is a hardware and communication flow diagram of the touch-sensitive input overlay.

FIG. 3 is a diagram of additional data structure attributes useful in implementing the touch-sensitive input overlay.

FIG. 4 is a flowchart detailing acts corresponding to implementing the touch-sensitive input overlay.

FIGS. 5-7 depict embodiments of touch-sensitive input overlays.

### DETAILED DESCRIPTION OF THE PREFERRED EMBODIMENTS

I describe improvements to graphical user interface systems, and in particular to methods and apparatuses for implementing a touch-sensitive graphical user interface. According to an aspect of my invention, a touch-sensitive input overlay is presented on the graphical user interface in response to a touch input on a display device, which includes a touch input device, such a series of capacitive or resistive sensors disposed over the display device. The touch-sensitive input overlay allows a user of a computer system to perform entry options without the aid of a traditional keyboard or mouse, but rather by touching one or more entry options presented on the touch-sensitive input overlay. The GUI system described herein is dynamic and flexible—allowing presentation of a number of unique touch-sensitive input overlays in variable locations on the display device. These and other advantages of the invention will be apparent to one of skill in the art upon review of the accompanying figures and the detailed description below.

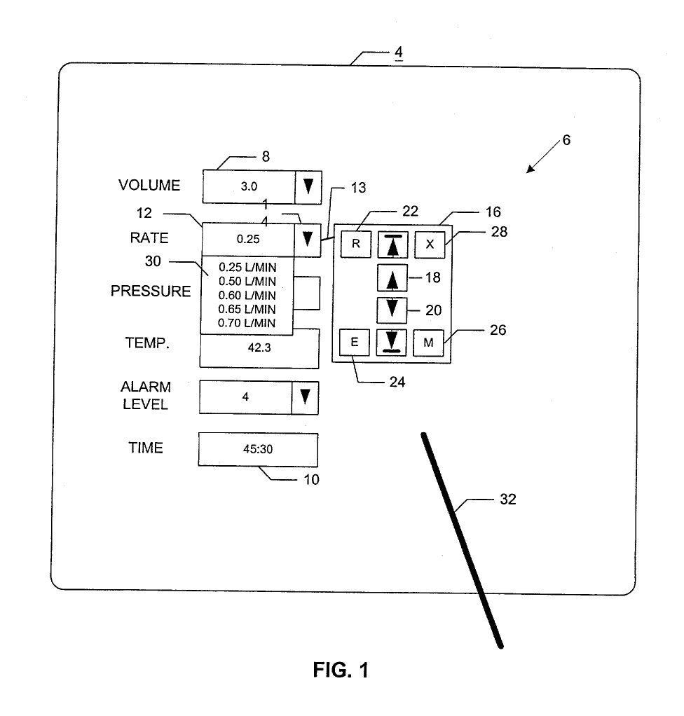

Turning first to FIG. 1, it illustrates a touch-sensitive input overlay 16, which is disposed over a traditional GUJI 6 presented on a display device 4. According to an aspect of the invention, the display device 4 includes a touch input device that is responsive to physical contact. Such devices are commercially available and generally known in the art.

The GUI 6 comprises a series of visual indicators, which include control boxes 8, 10, and 12 for data entry, but can also include navigation entry fields (not shown) such as a tree-hierarchy. For instance, the control 12 is shown with a push-down button 14, which opens to a list box 30. Other types of controls can include combo boxes, push and toggle buttons, progress indicators, scroll bars, window edges (that facilitate resizing of a window), and other devices for display, inviting, responding, or accepting information between a user and a computer program.

I note that a “control” is an area or entry dialog/window into which data can be entered (note that a “control” is sometimes called a “widget” in Unix environments). A GUI comprises a plurality of controls, and in a normal GUI environment, a keyboard and mouse are shared among a number of controls. However, when the keyboard or mouse “focuses” on a particular control, that control has the attribute of receiving the keyboard or mouse entries (e.g., from a message queue of a thread that created it). Thus, as a particular control is selected, it “has focus” in the GUI. There can be only one focus (i.e. control) active in the GUI at any given time.

The GUI 6 does not have to be a specially programmed GUI—that is, it does not have to be a GUI programmed for touch-sensitive input. And herein lies an advantage of my invention: using an off-the-shelf touch input device, such as a touch-sensitive display, and the methods and techniques described herein, a highly flexible and useful touch-sensitive input overlay for the GUI is possible that either replaces or complements traditional data entry and navigation tools used with a standard GUI.

When a user touches within a pre-set area around a control (e.g., 8, 10, 12) (hereinafter referred to as a “parent control”) on the GUI 6, the touch-sensitive input overlay 16 appears on the screen 4 in the proximity of the parent control (now having focus), effectively overriding standard processing of data/control selection and entry. A parent control delineator 13 is shown that correlates the parent control 12 to the touch-sensitive input overlay 16.

According to one embodiment, the touch-sensitive input overlay is animated onto the screen from one or more points corresponding to the parent control to multiple points corresponding to the ultimate location touch-sensitive input overlay. For instance, rather than simply appearing in its fully rendered state, the touch-sensitive input overlay is gradually expanded or “faded-in” from the parent control to its full-size adjacent to the parent control—not so fast that it cannot be detected by a user's eye, but not so slow that it consumes too much time.

In another embodiment, the touch-sensitive input overlay can fade-in or pop-up on the screen and a portion of the border of the touch-sensitive input overlay closest to the parent control is delineated in a position corresponding to the parent control so as to identify the touch-sensitive input overlay with the parent control. For instance, the border can be partially removed, highlighted, or a line drawn to the parent control from a point along the border of the touch-sensitive input overlay. In yet another embodiment, the background of the graphical user interface can be faded out or turned into non-active color schemes (the standard windowing technique for highlighting the active dialog window), while the touch-sensitive input overlay is highlighted or turned into the active color schemes.

The objective in each of these techniques is to aid in allowing a user to identify the parent control for the touch-sensitive input overlay.

The touch-sensitive input overlay 16 can have a number of embodiments, which are pre-selected to best match the individual control parameters—such as control purpose (data entry or navigation) and type of data to be entered (numerical, list box, computed, user prompted, etc.). According to one embodiment, the position of the touch-sensitive input overlay 16 relative to the parent control depends on the parent control's location within the display and the unused GUI area within the proximity of the parent control. It is desirable to place the input overlay in a position where it is least obtrusive to adjacent controls or other on-screen information.

As shown in FIG. 1, the touch-sensitive input overlay 16, which is suited for navigation in a list box, includes a number of touch entry options including a plurality of navigation arrows 18 and 20, a “reset” option 22 (for resetting a control), and an “enter” option 24 (for entry of a selected data item in a list box 30). Optionally, a “move” option 26 (for allowing a user to move the input overlay 16 to a different location on the display 4), and a “close” option 28, for exiting the touch-sensitive input overlay 16 (i.e., making it disappear), can be included. However, it is often preferred to minimize not only the complexity of the touch-sensitive input overlay 16, but also the real estate. Thus, in another embodiment, only strictly essential options are include in the touch-sensitive input overlay 16. Tasks such as closing the touch-sensitive input overlay, for instance, can be achieved simply by selecting another control and giving it focus.

A touch tool 32, is also shown, which can be a plastic pointer or, preferably, a human finger. The touch tool 32 is used to register a selection onto the touch input device. The dimensions of the graphic touch entry options on the touch-sensitive input overlay 16 are sized to allow easy selection by a human finger or the physical pointer device.

While only one touch-sensitive input overlay 16 is shown in FIG. 1, I envision other types of touch-sensitive input overlays as well, such as a numeric pad (also called an “addition control”), an abbreviated keypad, and a navigation pad with four directions of movement selection, as well as other options consistent with traditional navigation support. Some of these embodiments are presented below and in the accompanying figures.

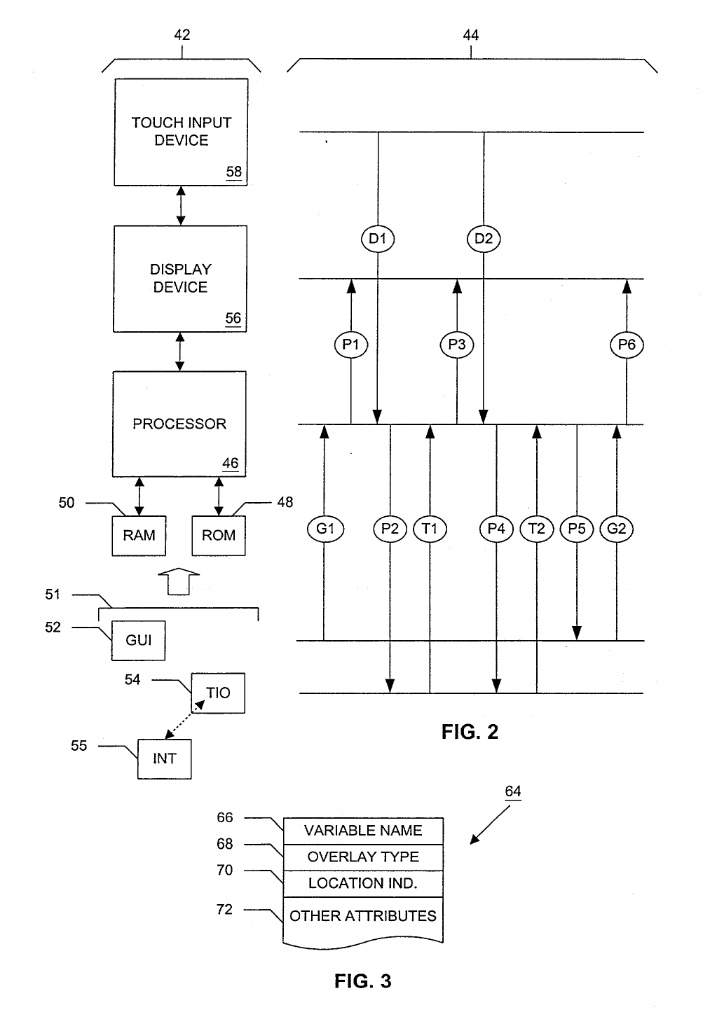

FIG. 2 is a hardware and communication flow diagram of the touch-sensitive input overlay. The left side of the diagram shows a functional overview of the hardware and software components 42, while the right side shows a general data and functional flow graph 44 between these components.

Beginning with the hardware and software components 42, these are shown as the primary functional components of a system in which my invention can be deployed. A microprocessor 46 is the primary agent for executing program modules and instructions and communicating between devices. In normal operation, this is achieved through additional components (not shown) such as an operating system and device drivers stored in memory. The microprocessor 46 has access to at least two such memory areas: an execution memory 50 (such as RAM) and a persistent memory 48 (such as ROM and disk storage). The microprocessor 46 is further communicatively coupled to a display device 56, such as a cathode ray tube, active matrix, passive matrix, or liquid crystal display.

Preferably the display device 56 further includes a touch input capability, which is depicted as a touch input device 58, as it may be integrated with the display device 56 or a separate element capable of detecting a touch input on a display device (e.g., an optical or infrared sensors configured to intercept an object coming into contact with the display device 56, or a screen that overlays the display device 56). The touch input device 58, then, is configured to detect a touch input and generate a signal indicative of the touch input together with a signal indicative of the two dimensional coordinates identifying the location where the touch input was received relative to the touch input device 58 or display device 56. In this way, a particular control can become the focus.

If the functionality of the touch input device 58 is integrated into the display device 56, then communication between the touch input device 58 and microprocessor 46 will typically be handled through a communication link between the microprocessor 46 and display device 56.

Two GUI program modules 51 are called out from the memory areas 48 and 50 to emphasize an embodiment. The first is GUI program module 52, which is a standard GUI. By standard GUI, it is meant that an application program written over the operating system has a GUI that typically operates with the aid of a mouse or keyboard. (This standard GUI does not have to be modified according to an embodiment of my invention.)

The GUI module 52 can be implemented in a number of different programming languages and for a number of different applications. One example is a GUI programmed in VisualBasic (TM), available from Microsoft Corporation in Redmond, Wash., for a semiconductor manufacturing equipment. The GUI can include a number of controls designed to monitor and regulate the fabrication of semiconductors within the semiconductor manufacturing equipment. Another example is a GUI programmed with a Java (TM) development kit, such as an abstract window toolkit (AWT) or Swing toolkit. Java (TM) implementations of both are available from a number of vendors including Sun Microsystems, Inc. in Palo Alto, Calif. Moreover, the touch-sensitive input overlay can be used for entry of data for control, monitoring, or other record keeping operations for any industrial, commercial, or other purpose.

The standard GUI module 52 includes programming modules that handle data entry or navigation when it is entered with a mouse or keyboard into the parent control. The GUI module 52 further includes the graphics and program operation calls that can drive underlying application processes—for example calls to execute routines that create a new set point or parameter value for an external control process, or calls to routines that perform a calculation based on data that entered into the parent control.

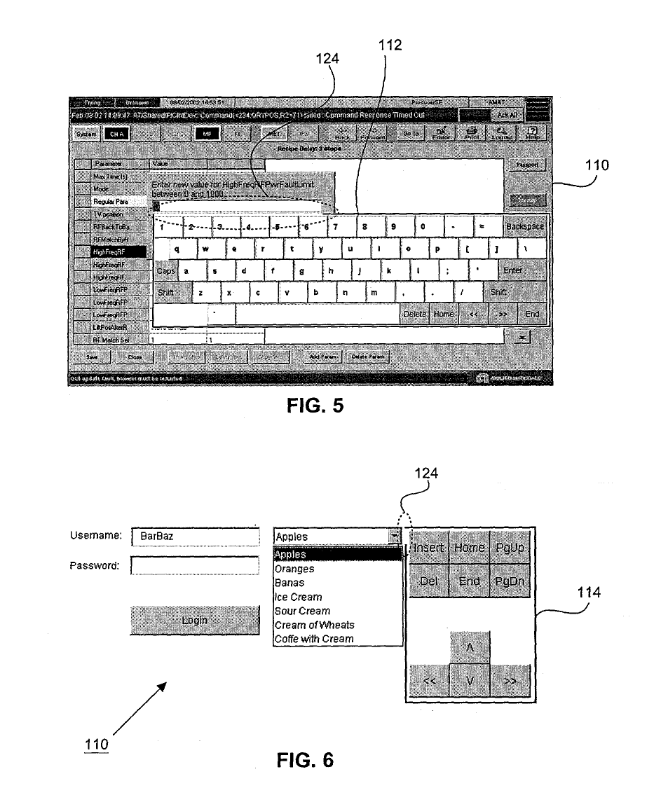

The touch-sensitive input overlay module 54 is new. Its primary function is to cause a touch-sensitive input overlay to be presented near a control when the control is touched (thus becoming the focus), and generate command/input signals for further processing by the touch-sensitive input overlay module 54, as well as the GUI module 52. This function can supplant the role of the keyboard, thereby allowing a user to enter data directly into the touch-sensitive input overlay through one or more “touch key” commands directed toward the touch input device 58. Additional details of the touch-sensitive input overlay module 54 are provided below with reference to FIG. 4.

According to one embodiment, the touch-sensitive input overlay module 54 includes an interpreter module 55 that is configured to translate touch inputs received in the touch-sensitive input overlay into corresponding keyboard entries so they can be passed along to the microprocessor 46, which, in turn, passes them along o the GUI module 52 or the application program (e.g., by adding them to a queue associated with a particular thread). However, in other embodiments, such an interpreter module 55 can be added to the operating system so that incoming touch inputs from the touch input device 58 can be processed without passing through the touch-sensitive input overlay module 54.

Turning to the functional flow graph 44, a horizontal line is shown to each element in the function component stack 42. An arrow shows a direction of communication travel. The description begins with the GUI module 52 instructing the microprocessor 46 to present graphical information (GI). In turn, the microprocessor issues instructions (P1) that cause the display device 56 to present the graphical information, which includes controls.

Once the graphical information is presented, a touch input is received at the touch input device 58, which then sends a signal (D1) back to the microprocessor 46 indicating that a touch-input has been received. The signal (D1) preferably includes location information indicating coordinates where the touch input was received. The signal is received at the microprocessor 46.

The microprocessor 46 then calls (P2) programming modules of the touch-sensitive input overlay module 54 to correlate the coordinates of the touch input to a location on the GUI created by the GUI module 52, and to determine the type and location of the touch-sensitive input overlay to present on the display device 56 with the control (now a focus). When the touch-sensitive input overlay is selected, graphics information (T1) is sent back to the microprocessor 46 so that it can be presented on the display device 56.

The microprocessor 46 then sends signals (P3) to the display device 56 so that the touch-sensitive input overlay is visible. When a subsequent touch input is received at the touch input device 58, a signal (D2) is again sent to the microprocessor 46. The microprocessor 46 forwards the signal (P42) to the touch-sensitive input overlay modules 54, which generate signals (T2) for the microprocessor 46, which, in turn sends signals (P5) to the GUI module 52. When the GUI module 52 receives the signals (P5), it will generate signals (G2) for the underlying application program (and display device 56) that indicate which functions should be performed in response to the touch input signals (D2). These signals (G2) are handled by the microprocessor 46, which sends display update signals (P6) to the display device 56 so that updated information is presented on the GUI.

According to an embodiment, from the perspective of the GUI module 52, there is no difference between a keyboard/mouse input and an input received and processed by the touch input device 58 and touch-sensitive input overlay module 54 (and interpreter 55)—these aspects are transparent to the GUI module 52.

According to an embodiment, I can modify a standard GUI that is not programmed for touch-screen input and use one or more data structures and processing techniques completely separate from the standard GUI and facilitate a touch-screen input. Thus, my invention works well with legacy windowing systems and graphical user interfaces and does not necessarily require modification of the standard GUI. However, while a standard GUI can be used according to an embodiment of the invention, the addition of certain data structures directly to the GUI or supplementing the GUI can be advantageous.

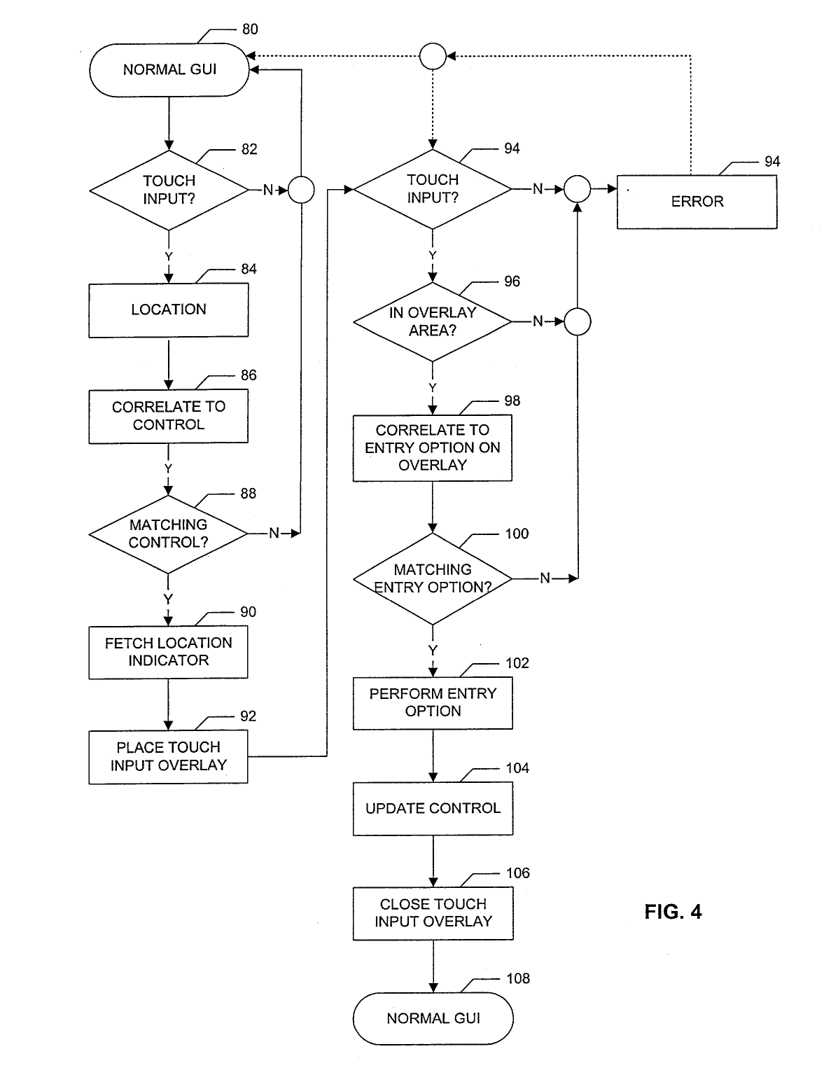

Turning to FIG. 3, it depicts a touch-sensitive input overlay selector data structure 64 that can be includes to the program modules 51 to facilitate optimization of the overlay type (various types of overlays are presented below) and parameters. Again, however, this aspect is merely optional, as metadata from the GUI itself can be read to determine such parameters (e.g., by reading field properties or tags in the underlying GUI or application program).

Included in the data structure 64 are three fields. The first is the variable name 66, the second is the overlay type 68, and the third is the location indicator 70. The variable name field 66 is used to identify a particular control being operated on. The overlay type field 68 indicates which of a number of overlay types is best for entering data or selections into the control. For instance, a numeric pad may be best for data entry, or a scroll bar may be preferred for a list box. The location indicator field 70 is used to specify a preferred positioning or placement coordinates for the touch-sensitive input overlay when it is presented near the control. The location indicator field 70 is most helpful where the GUI is complex, crowded, or prior control entries are helpful in making a current control entry into the touch-sensitive input overlay. For example, the location indicator field 70 can specify a region on the screen to place the touch-sensitive input overlay so it will not obstruct the view of other control fields or on-screen information, and so that it does not get placed out of view of the display area of the display device 56. As well, the location indicator can specify or cross-reference other variable names 66 or controls that are desired to be visible when the parent control has focus.

Additional or other attributes 72 can be specified too, such as special purpose touch buttons or options for particular control fields, such as default values, minimum values, maximum values, sub-touch-sensitive input overlay options (help menus, examples), etc. In particular the other attributes can include: information for a nested touch-input calculator within the touch-sensitive input overlay; a “transparent” mode button, which can allow for the touch-sensitive input overlay to become semi-transparent so data below the touch-sensitive input overlay is visible; or a touch-sensitive input overlay movement button, which can be employed by a user to manually reposition the touch-sensitive input overlay.

Further improvements on the touch-sensitive input overlay can include algorithms that account for various touch-input gestures received at the touch-sensitive input overlay, such as special “drag-and-drop”, movement, and character entry processing algorithms. For example, a first touch gesture on a specified region of the touch-sensitive input overlay 16 on the touch-input device 58, followed immediately by a second touch gesture, e.g., a continuous sweeping motion, followed next by a release of second touch gesture on the touch input device 58, can be perceived by the touch-sensitive input overlay module 54 as a traditional “drag-and-drop” function that is performed by a mouse, resulting in a change in placement or movement of the touch-sensitive input overlay 16 relative to its initial starting position.

FIG. 4 is a flowchart detailing computer implemented acts corresponding to implementing the touch-sensitive input overlay in an embodiment. According to an embodiment, the acts are stored as one or more sequences of instructions in a computer readable medium (or computer program modules). The sequences of instructions are typically stored in a persistent memory, such as memory 48, and just prior to execution they are copied or downloaded (e.g. from a network computer readable medium into a volatile execution memory area, such as memory 50, where they are executed by one or more microprocessors, such as microprocessor 46. While most of the acts are to be carried out by the touch-sensitive input overlay module 54, others can be distributed among other resources, such as through corresponding improvements to a standard GUI module 52, or in the underlying operating system or application program, if one is employed.

In act 80, the GUI is operating in normal mode—presenting text and graphics to a user on a display device 56, which can be replied to using a standard keyboard or mouse. An interrupt driven routine determines whether a touch input is received at the touch input device 58 in act 82. If no touch input is received, processing continues in normal GUI mode. However, if a touch input is received, then processing continues to act 84.

In act 84, a location where the touch input was received is generated. The location information can be computed, or it can be explicitly provided by nature of the sensors in the touch input device 58 that monitor for the touch input.

In act 86, the touch input is correlated to a control field, meaning that the location of the touch input is matched against the location of the nearest control field currently presented on the display device 56. This act, it is noted, can be performed by the touch-sensitive input overlay module 54 or another module that typically handles a mouse or keyboard entry that moves a cursor into the control field or highlights a dialog window on the GUI. Act 88 can be considered along with act 86, because in act 86, a determination is made as to whether a control field exists in the proximity of the touch input. In some cases, no control field will exist and thus no touch-sensitive input overlay will be presented, thus processing will continue to normal mode in act 80. In others, a default or general purpose touch-sensitive input overlay will be presented on the GUI that assists in general navigation. Nevertheless, receipt of the first touch input typically causes the target control to become the focus for the touch input device 58.

According to one embodiment, in act 90, location indicator information is fetched from a data structure (e.g. data structure 66) stored in memory. The location indicator information assists in determining where on the display device 56 the touch-sensitive input overlay should be presented on the display device 56. The location indicator information can include placement preferences, as are mentioned above, as well as general rules for preventing partial placement of the touch-sensitive input overlay outside of the visible area on the display device 56.

In act 92, the touch-sensitive input overlay is placed on the display device 56 in a location derived from the information from acts 84 and 90. Next, in act 94, the system waits for another (or a “second”) touch input from the touch input device 58. Act 94 can be another interrupt driven act, and/or it can be a timing driven act wherein the microprocessor 46 waits for a fixed period of time for a second touch input, and if one is not received then error processing acts 95 occur, such as presentation of a nested touch-sensitive input overlay to prompt a user for a reply or to cancel the touch input (the nested touch-sensitive input overlay being absolutely timed so processing continues regardless of whether a second touch input is received), or simply returning the normal GUI mode.

If a second touch input was received at act 94, then a test is performed in act 96 to determine whether the second touch input was within the boundary area of the touch-sensitive input overlay. If it was not, then it is ignored or error processing occurs, such as a dialog window prompting the user to re-enter the second touch input because it was out of bounds. However, if the second touch input was within the boundary area of the touch-sensitive input overlay, then the second touch input is correlated to an entry option on the touch-sensitive input overlay in act 98. Act 98 can include, for instance, correlation of the second touch input to a specific entry option such as depression of a button, key, or navigation guide.

As was the case with acts 86 and 88, acts 98 and 100 are inter-related. In 100, if there was not a matching entry option corresponding to the second touch input, then processing continues to an error processing mode substantially similar to the modes described in act 95—for example, giving a user another opportunity to enter a touch input. However, if a matching entry option is found, then in act 102, a signal corresponding to the entry option is sent from the touch-sensitive input module 54 to the microprocessor 46 so that the appropriate input operations are entered.

If the entry option involves more than a simple button selection, then this act can take place with the interpreter module 55 within the touch-sensitive input module 54, or within a similar interpreter module in the application program, or more preferably within the operating system. In such an embodiment, the interpreter module 55 can be invoked on the first touch entry received (so the first entry has two functions: invocation of the interpreter module 55 and selection of a first entry), while subsequent touch input entries into the touch-sensitive input overlay are transformed into corresponding signals matching keyboard or mouse-type entries by the now executing interpreter module 55.

In act 104, the subject control field is updated, meaning the transformed signals are committed to the field, thus updating the primary GUI control field with the corresponding input. Next, in act 106, the touch-sensitive input overlay is closed and in act 108, processing resumes to normal GUI mode until a next touch input is detected (act 82).

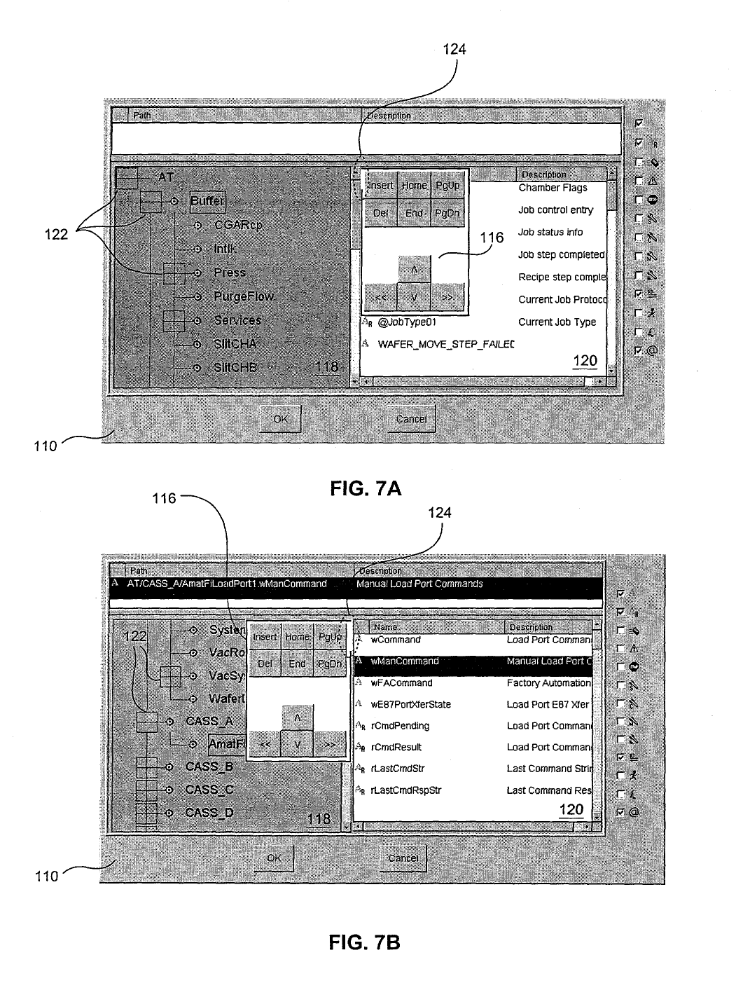

FIGS. 5-7 depict embodiments of touch-sensitive input overlays that can be used over a standard GUI 110 in accordance with the invention. FIG. 5 depicts an embodiment of a touch-sensitive keyboard input overlay 112, but a touch-sensitive numeric pad input overlay could also be employed. FIG. 6 depicts an embodiment of a touch-sensitive navigation input overlay 114. In each of these embodiments, a parent control delineator 124, here a cutout from the touch-sensitive input overlay, is shown that is disposed between the touch-sensitive input overlay and the parent control. This parent control delineator, which is shown in each of FIGS. 5-7 assists in identifying the parent control that corresponds to the touch-sensitive input overlay.

FIGS. 7A-B depict a more complicated tree-hierarchy navigation GUI with a touch-sensitive navigation pad input overlay 116. In this embodiment, the GUI 110 is separated into two adjustable areas 118 and 120. On the left side, area 118, a navigation tree is augmented by enlarged touch-input control fields 122. The fields can be navigated by physical touch directly on the control fields, or by depressing an entry option on the touch-sensitive input overlay 116. While one side of the screen is active, the touch-sensitive input overlay 116 is placed on the opposite side of the screen. However, once a selection is made, the touch-sensitive input overlay 116 is moved to the other side of the screen. (Note further the placement of the parent control delineator 124.)

It will be appreciated by one of skill in the art that various functional software or hardware components can be achieved in a single software and/or hardware component or multiple software and/or hardware components. The methods, systems and techniques described herein can thus be incorporated into a variety of functional or physical combinations of components.

I have described a touch-sensitive input overlay for use with a graphical user interface. The systems and methods described herein are useful in a number of graphical user interface applications, and in particular to industrial control environments, such as semiconductor manufacturing equipment. My invention aids in the programming of flexible and convenient graphical user interfaces, especially in environments where usr interaction with a traditional keyboard or mouse is not convenient or practical. While specific examples and details are described above, I do not intended to limit the scope of my invention to any embodiment described or depicted herein, but rather only by the claims that follow.

What is claimed is:

1. A graphical user interface system comprising:
a computer including: a microprocessor, a display communicatively coupled to the microprocessor and configured to display text and images, and further configured to receive a touch input from a user, and a memory communicatively coupled to the microprocessor, the memory comprising one or more program modules configured to cause the microprocessor to execute a graphical user interface on the display, and in which the one or more program modules are further configured to:
determine a location of a first touch input received on the display;
correlate the first touch input to a control on the graphical user interface;
determine a location to present a touch-sensitive input overlay relative to the control;
place the touch-sensitive input overlay at the location; and
receive a second touch input in the area defined by the touch-sensitive input overlay, the second touch input aiding entry of a parameter into the control.

2. The graphical user interface system of claim 1, wherein the touch-sensitive input overlay includes navigation guides configured to allow navigation within a list box control.

3. The graphical user interface system of claim 1, wherein the touch-sensitive input overlay includes navigation guides configured to allow navigation within a tree control.

4. The graphical user interface system of claim 1, wherein the touch-sensitive input overlay includes a numeric pad for entry of data into the control.

5. The graphical user interface system of claim 1, wherein the control includes a location indicator configured to direct placement of the touch-sensitive input overlay in an unobtrusive location relative to the control.

6. The graphical user interface system of claim 1, the one or more program modules further configured to:
receive a first touch gesture at a location in the touch-sensitive input overlay;
receive a second touch gesture at the display; and
move the touch-sensitive input overlay relative to the second touch gesture.

7. The graphical user interface system of claim 1, the one or more program modules further configured to present a control delineator on a border of the touch-sensitive input overlay corresponding to the control.

8. The graphical user interface system of claim 1, the one or more program modules further configured to animate the touch-sensitive input overlay from one or more points corresponding to the control to multiple points corresponding to the location touch-sensitive input overlay.

9. The graphical user interface system of claim 1, wherein the touch-sensitive input overlay is semi-transparent.

10. A computer implemented method for a graphical user interface system including instructions for causing one or more processors to perform the acts comprising:
determining a location of a first touch input received on a display;
correlating the first touch input to a control on a graphical user interface presented on the display;
determining a location to present a touch-sensitive input overlay relative to the control;
placing the touch-sensitive input overlay at the location; and
receiving a second touch input in the area defined by the touch-sensitive input overlay, the second touch input aiding entry of a parameter into the control.

11. The method of claim 10, wherein in response to receiving the second touch input, the method further comprises the act of navigating a list box control.

12. The method of claim 10, wherein in response to receiving the second touch input, the method further comprises the act of navigating a tree control.

13. The method of claim 10, further comprising determining a type of touch-sensitive input overlay to present on the display, the type of touch-sensitive input overlay varying depending on information corresponding to the control.

14. The method of claim 13, further comprising storing a location indicator with the control, the location indicator configured to direct placement of the touch-sensitive input overlay in an unobtrusive location relative to the control.

15. The method of claim 10, further comprising:
receiving a first touch gesture at a predetermined location in the touch-sensitive input overlay;
receiving a second touch gesture at the display; and
moving the touch-sensitive input overlay relative to the second touch gesture.

16. The method of claim 10, further comprising:
receiving a touch-transparent input at a predetermined location on the touch-sensitive input overlay; and
modifying the presentation of the touch-sensitive input overlay such that it is semi-transparent and reveals information from the underlying graphical user interface, in reply to the touch-transparent input.

17. The method of claim 10, further comprising presenting a control delineator on a border of the touch-sensitive input overlay corresponding to the control.

18. The method of claim 10, further comprising animating the touch-sensitive input overlay from one or more points corresponding to the control to multiple points corresponding to the location touch-sensitive input overlay.

19. A computer readable medium having stored thereon one or more sequences of instructions configured to cause one or more microprocessors to perform the acts comprising:
determining a location of a first touch input received on a display;
correlating the first touch input to a control on a graphical user interface presented on the display;
determining a location to present a touch-sensitive input overlay relative to the control;
placing the touch-sensitive input overlay at the location; and
receiving a second touch input in the area defined by the touch-sensitive input overlay, the second touch input aiding entry of a parameter into the control.

20. The computer readable medium of claim 19, wherein in response to receiving the second touch input, the method further comprises the act of navigating a list box control.

21. The computer readable medium of claim 19, wherein in response to receiving the second touch input, the method further comprises the act of navigating a tree control.

22. The computer readable medium of claim 19, further comprising instructions configured to cause one or more microprocessors to perform the act of determining a type of touch-sensitive input overlay to present on the display, the type of touch-sensitive input overlay varying depending on information corresponding to the control.

23. The computer readable medium of claim 22, further comprising instructions configured to cause one or more microprocessors to perform the act of storing a location indicator with the control, the location indicator configured to direct placement of the touch-sensitive input overlay in an unobtrusive location relative to the control.

24. The computer readable medium of claim 19, further comprising instructions configured to cause one or more microprocessors to perform the acts of:
receiving a first touch gesture at a predetermined location in the touch-sensitive input overlay;
receiving a second touch gesture at the display; and
moving the touch-sensitive input overlay relative to the touch gesture.

25. The computer readable medium of claim 19, further comprising instructions configured to cause one or more microprocessors to perform the acts of:
receiving a touch-transparent input at a predetermined location on the touch-sensitive input overlay; and
modifying the presentation of the touch-sensitive input overlay such that it is semi-transparent and reveals information from the underlying graphical user interface, in reply to the touch-transparent input.

26. The computer readable medium of claim 19, further comprising instructions configured to cause one or more microprocessors to perform the act of presenting a control delineator on a border of the touch-sensitive input overlay corresponding to the control.

27. The computer readable medium of claim 19, further comprising instructions configured to cause one or more microprocessors to perform the act of animating the touch-sensitive input overlay from one or more points corresponding to the control to multiple points corresponding to the location touch-sensitive input overlay.
